(19) United States
(12) Patent Application Publication
(10) Pub. No.: US 2024/0380131 A1
(43) Pub. Date: Nov. 14, 2024

(54) Electrical Connection Assembly and Charging Seat Assembly

(71) Applicants: Tyco Electronics (Shanghai) Co., Ltd., Shanghai (CN); Tyco Electronics Technology (SIP) Co., Ltd., Suzhou (CN)

(72) Inventors: Ming Xu, Suzhou (CN); Fangyue (Jason) Zhu, Shanghai (CN)

(73) Assignees: Tyco Electronics (Shanghai) Co., Ltd., Shanghai (CN); Tyco Electronics Technology (SIP) Co., Ltd., Suzhou (CN)

(21) Appl. No.: 18/659,178

(22) Filed: May 9, 2024

(30) Foreign Application Priority Data
May 9, 2023 (CN) 202321094039.5

(51) Int. Cl. H01R 4/06

(52) U.S. Cl. CPC H01R 4/06

(57) ABSTRACT

An electrical connection assembly includes a first metal bar and a second metal bar. The first metal bar has a first main body portion, a first connection end portion, and a first bending portion connected between them. The second metal bar has a second main body portion, a second connection end portion, and a second bending portion connected between them. The first metal bar and the second metal bar are separated in a thickness direction and parallel to each other when the first metal bar and the second metal bar are electrically connected to a charging seat. The first main body portion and the second main body portion overlap with each other in the thickness direction. The first connection end portion and the second connection end portion are staggered in a width direction.

### CROSS-REFERENCE TO RELATED APPLICATION

This application claims the benefit of the filing date under 35 U.S.C. § 119 (a)-(d) of Chinese Patent Application No. 202321094039.5, filed on May 9, 2023.

### FIELD OF THE INVENTION

The present invention relates to an electrical connection assembly for electrically connecting with a charging seat and a charging seat assembly comprising the electrical connection assembly.

### BACKGROUND

In the prior art, copper wires are usually used to electrically connect the charging terminals of the charging seat. The copper wire is soldered or crimped with the charging terminal before being installed into the housing of the charging seat. The existing electrical connection method has a single form, poor flexibility, cannot be freely combined, and has low compatibility.

### SUMMARY

An electrical connection assembly includes a first metal bar and a second metal bar. The first metal bar has a first main body portion, a first connection end portion, and a first bending portion connected between them. The second metal bar has a second main body portion, a second connection end portion, and a second bending portion connected between them. The first metal bar and the second metal bar are separated in a thickness direction and parallel to each other when the first metal bar and the second metal bar are electrically connected to a charging seat. The first main body portion and the second main body portion overlap with each other in the thickness direction. The first connection end portion and the second connection end portion are staggered in a width direction.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a charging seat assembly according to an exemplary embodiment of the present invention;

FIG. 2 shows an illustrative exploded view of a charging seat assembly according to an exemplary embodiment of the present invention;

FIG. 3 shows an illustrative perspective view of the first metal bar and the second metal bar according to an exemplary embodiment of the present invention; and

FIG. 4 shows an illustrative perspective view of the first charging terminal and the second charging terminal according to an exemplary embodiment of the present invention.

### DETAILED DESCRIPTION OF EMBODIMENTS

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

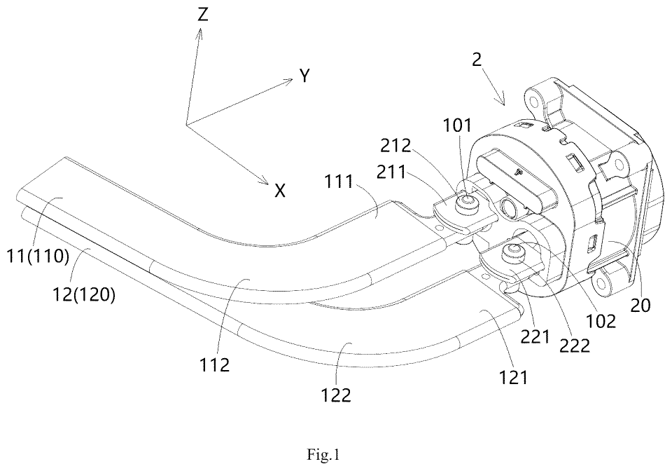

As shown in FIGS. 1 to 4, in an exemplary embodiment of the present invention, an electrical connection assembly is disclosed. The electrical connection assembly includes a first metal bar 11 and a second metal bar 12. The first metal bar 11 is flat, including a straight first main body portion 110, a straight first connection end portion 111, and a first bending portion 112 connected between the first main body portion 110 and the first connection end portion 111. The second metal bar 12 is flat, including a straight second main body portion 120, a straight second connection end portion 121, and a second bending portion 122 connected between the second main body portion 120 and the second connection end portion 121.

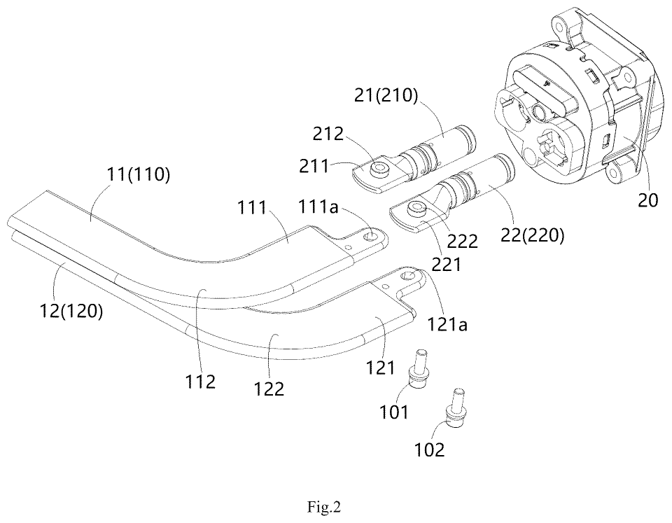

As shown in FIGS. 1 and 2, in the illustrated embodiments, the first connection end portion 111 and the second connection end portion 121 are respectively electrically connected to a first charging terminal 21 and a second charging terminal 22 of the charging seat 2. When the first metal bar 11 and the second metal bar 12 are electrically connected to charging seat 2, the first metal bar 11 and the second metal bar 12 are spaced apart and parallel to each other in their thickness direction Z. The first main body portion 110 and the second main body portion 120 overlap with each other in their thickness direction Z, and the first connection end portion 111 and the second connection end portion 121 are staggered in their width direction X.

As shown in FIGS. 1 to 3, in the illustrated embodiments, the first main body portion 110 of the first metal bar 11 and the second main body portion 120 of the second metal bar 12 have the same width and each has left and right sides opposite to each other in their width direction. When the first metal bar 11 and the second metal bar 12 are connected to the charging seat 2, the left and right sides of the first main body portion 110 of the first metal bar 11 are flush with the left and right sides of the second main body portion 120 of the second metal bar 12.

As shown in FIGS. 1 and 2, in the illustrated embodiments, the electrical connection assembly includes a first connection member 101 and a second connection member 102. The first connection member 101 is used to connect one end of the first connection end portion 111 of the first metal bar 11 to one end of the first charging terminal 21. The second connection member 102 is used to connect one end of the second connection end portion 121 of the second metal bar 12 to one end of the second charging terminal 22.

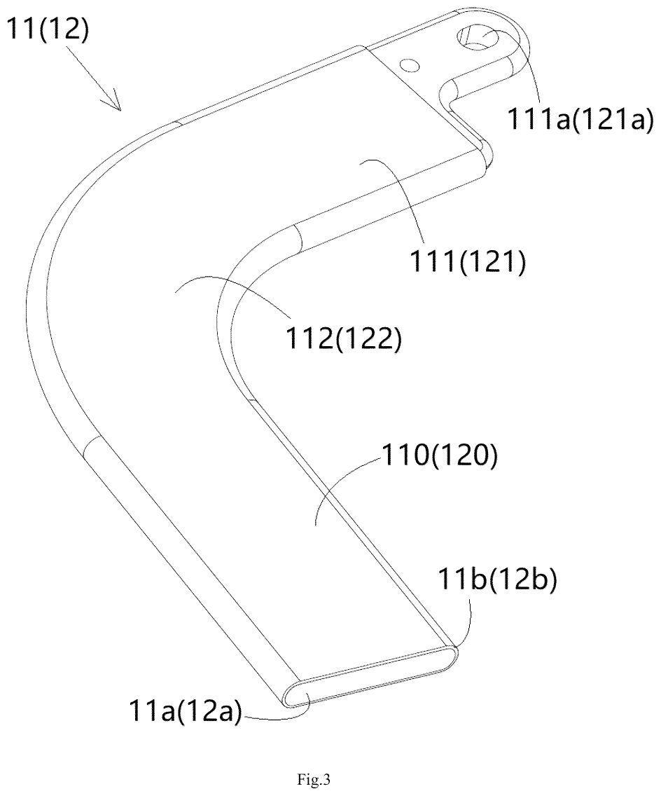

As shown in FIGS. 2 and 3, in the illustrated embodiments, a first connection hole 111a is formed in one end of the first connection end portion 111 of the first metal bar 11. The first connection member 101 passes through the first connection hole 111a and is suitable for threaded connection with a first nut 212 on the first charging terminal 21 to tighten one end of the first connection end portion 111 of the first metal bar 11 to one end of the first charging terminal 21.

As shown in FIGS. 2 and 3, in the illustrated embodiments, a second connection hole 121a is formed in one end of the second connection end portion 121 of the second metal bar 12. The second connection member 102 passes through the second connection hole 121a and is suitable for threaded connection with a second nut 222 on the second charging terminal 22 to tighten one end of the second connection end portion 121 of the second metal bar 12 to one end of the second charging terminal 22.

As shown in FIG. 3, in the illustrated embodiments, the size of the first connection hole 111a in the length direction Y of the first connection end portion 111 is greater than the size of the first connection hole 111a in the width direction X of the first connection end portion 111, allowing the first connection member 101 to move along the length direction Y of the first connection end portion 111 in the first connection hole 111a. In the illustrated embodiments, the size of the second connection hole 121a in the length direction Y of the second connection end portion 121 is greater than the size of the second connection hole 121a in the width direction X of the second connection end portion 121, so that the second connection member 102 can be moved along the length direction Y of the second connection end portion 121 in the second connection hole 121a.

When the first metal bar 11 and the second metal bar 12 are electrically connected to the charging seat 2, the central axis of the first connection hole 111a and the central axis of the second connection hole 121a are parallel to each other and located in the same plane perpendicular to the length direction Y of the first connection end portion 111 and the second connection end portion 121.

As shown in FIG. 3, in the illustrated embodiments, the first metal bar 11 has a flat first metal conductor 11a and a first insulation layer 11b wrapped on the first metal conductor 11a. One end of the first metal conductor 11a is exposed out of the first insulation layer 11b for electrical connection to the first charging terminal 21. The second metal bar 12 has a flat second metal conductor 12a and a second insulation layer 12b wrapped on the second metal conductor 12a, with one end of the second metal conductor 12a exposed out of the second insulation layer 12b for electrical connection to the second charging terminal 22. In the illustrated embodiments, the first metal bar 11 and the second metal bar 12 may be aluminum bars or other suitable types of metal bars. In some exemplary embodiments according to the present invention, using aluminum bars instead of traditional copper wires can not only reduce the weight of the charging seat product, but also greatly reduce production costs.

As shown in FIG. 1, in another exemplary embodiment of the present invention, a charging seat assembly is also disclosed. The charging seat assembly includes the aforementioned electrical connection assembly and a charging seat 2. The charging seat 2 includes a housing 20, a first charging terminal 21, and a second charging terminal 22. The first charging terminal 21 and the second charging terminal 22 are provided in the housing 20.

As shown in FIG. 1, in the illustrated embodiments, one ends of the first charging terminal 21 and the second charging terminal 22 extend out of the housing 20 and are electrically connected to one ends of the first metal bar 11 and the second metal bar 12 of the electrical connection assembly, respectively. In the illustrated embodiment, the length of the first charging terminal 21 and the second charging terminal 22 are the same, and the length extending from the housing 20 is also the same.

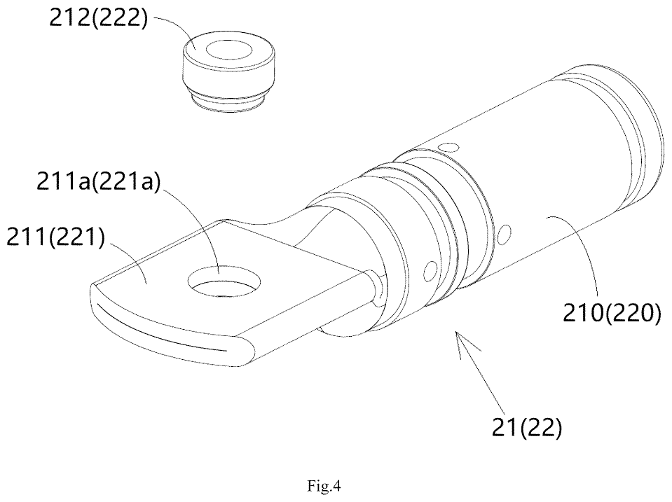

As shown in FIG. 4, in the illustrated embodiments, the first charging terminal 21 includes a first cylindrical body 210, a first flat end 211, and a first nut 212. The first cylindrical body 210 is used for mating with a first mating terminal of a charging gun. The first flat end 211 is electrically connected to the first connection end portion 111 of the first metal bar 11. The first nut 212 is riveted to a first riveting hole 211a formed in the first flat end 211. The first nut 212 is threaded to the first connection member 101 to tighten the first connection end portion 111 to the first flat end 211.

The second charging terminal 22 similarly includes a second cylindrical body 220, a second flat end 221, and a second nut 222. The second cylindrical body 220 is used for mating with a second mating terminal of the charging gun. The second flat end 221 is electrically connected to the second connection end portion 121 of the second metal bar 12. The second nut 222 is riveted into a second riveting hole 221a formed in the second flat end 221. The second nut 222 is threaded to the second connection member 102 to secure the second connection end portion 121 to the second flat end 221.

As shown in FIGS. 1 and 2, in the illustrated embodiments, the first flat end 211 and the second flat end 221 are spaced apart in their thickness direction Z and parallel to the first connection end portion 111 and the second connection end portion 121. The central axis of the first riveting hole 211a and the central axis of the second riveting hole 221a are parallel to each other and located in the same plane perpendicular to the central axes of the first cylindrical body 210 and the second cylindrical body 220. The central axes of the first cylindrical body 210 and the second cylindrical body 220 are parallel to each other and located in the same plane perpendicular to the thickness direction Z of the first flat end 211 and the second flat end 221.

In some exemplary embodiments of the present invention, the metal bar 11, 12 can be detachably connected to the charging terminal 21, 22 of the charging seat 2 through bolts, improving the connection efficiency, convenience, and compatibility of the metal bar.

In addition, in some exemplary embodiments according to the present invention, the main body 110, 120 of the metal bar 11, 12 is arranged in a stacked manner, which can reduce the volume of the charging seat product.

In addition, in some exemplary embodiments according to the present invention, the elongated connection hole 111a, 121a enables the metal bar 11, 12 to have greater inclusiveness and compatibility with larger assembly tolerances, enabling the metal bar 11, 12 to be quickly and conveniently connected to the charging terminal 21, 22. Therefore, it can improve the production efficiency and maintenance efficiency of the charging seat product in the later stage.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. An electrical connection assembly, comprising:
a first metal bar that is flat and has a first main body portion that is straight, a first connection end portion that is straight, and a first bending portion connected between the first main body portion and the first connection end portion; and
a second metal bar that is flat and has a second main body portion that is straight, a second connection end portion that is straight, and a second bending portion connected between the second main body portion and the second connection end portion, the first connection end portion electrically connects to a first charging terminal of a charging seat and the second connection end portion electrically connects to a second charging terminal of the charging seat, the first metal bar and the second metal bar are separated in a thickness direction and parallel to each other when the first metal bar and the second metal bar are electrically connected to the charging seat, the first main body portion and the second main body portion overlap with each other in the thickness direction, the first connection end portion and the second connection end portion are staggered in a width direction.

2. The electrical connection assembly of claim 1, wherein the first main body portion of the first metal bar and the second main body portion of the second metal bar have a same width.

3. The electrical connection assembly of claim 2, wherein the first main body portion and the second main body portion each have a left side and a right side opposite the left side in the width direction, the left side of the first main body portion is flush with the left side of the second main body portion and the right side of the first main body portion is flush with the right side of the second main body portion when the first metal bar and the second metal bar are electrically connected to the charging seat.

4. The electrical connection assembly of claim 3, further comprising:
a first connection member connecting an end of the first connection end portion to an end of the first charging terminal; and
a second connection member connecting an end of the second connection end portion of the second metal bar to an end of the second charging terminal.

5. The electrical connection assembly of claim 4, wherein a first connection hole is formed in the end of the first connection end portion, the first connection member passes through the first connection hole and forms a threaded connection with a first nut on the first charging terminal to tighten the end of the first connection end portion to the end of the first charging terminal.

6. The electrical connection assembly of claim 5, wherein a second connection hole is formed in the end of the second connection end portion, the second connection member passes through the second connection hole and forms a threaded connection with a second nut on the second charging terminal to fasten the end of the second connection end portion to the end of the second charging terminal.

7. The electrical connection assembly of claim 5, wherein a size of the first connection hole in a length direction of the first connection end portion is greater than a size of the first connection hole in the width direction of the first connection end portion, the first connection member is movable along the length direction of the first connection end portion in the first connection hole.

8. The electrical connection assembly of claim 6, wherein a size of the second connection hole in a length direction of the second connection end portion is greater than a size of the second connection hole in the width direction of the second connection end portion, the second connection member is movable along the length direction of the second connection end portion in the second connection hole.

9. The electrical connection assembly of claim 6, wherein a central axis of the first connection hole and a central axis of the second connection hole are parallel to each other and located in a same plane perpendicular to a length direction of the first connection end portion and the second connection end portion.

10. The electrical connection assembly of claim 6, wherein the first metal bar includes a first metal conductor that is flat and a first insulation layer wrapped on the first metal conductor, an end of the first metal conductor is exposed from the first insulation layer for electrical connection to the first charging terminal.

11. The electrical connection assembly of claim 10, wherein the second metal bar includes a second metal conductor that is flat and a second insulation layer wrapped on the second metal conductor, an end of the second metal conductor is exposed from the second insulation layer for electrical connection to the second charging terminal.

12. The electrical connection assembly of claim 1, wherein the first metal bar and the second metal bar are each made of aluminum.

13. A charging seat assembly, comprising:
an electrical connection assembly, including:
a first metal bar that is flat and has a first main body portion that is straight, a first connection end portion that is straight, and a first bending portion connected between the first main body portion and the first connection end portion; and
a second metal bar that is flat and has a second main body portion that is straight, a second connection end portion that is straight, and a second bending portion connected between the second main body portion and the second connection end portion, the first connection end portion electrically connects to a first charging terminal of a charging seat and the second connection end portion electrically connects to a second charging terminal of the charging seat, the first metal bar and the second metal bar are separated in a thickness direction and parallel to each other when the first metal bar and the second metal bar are electrically connected to the charging seat, the first main body portion and the second main body portion overlap with each other in the thickness direction, the first connection end portion and the second connection end portion are staggered in a width direction; and
a charging seat including a housing, a first charging terminal disposed in the housing, and a second charging terminal disposed in the housing, an end of the first charging terminal extends out of the housing and electrically connects to an end of the first metal bar, an end of the second charging terminal extends out of the housing and electrically connects to an end of the second metal bar.

14. The charging seat assembly of claim 13, wherein the first charging terminal includes a first cylindrical body mating with a first mating terminal of a charging gun, a first flat end electrically connected to the first connection end portion of the first metal bar, and a first nut riveted into a first riveting hole formed in the first flat end.

15. The charging seat assembly of claim 14, wherein the first nut is threaded to a first connection member to secure the first connection end portion to the first flat end.

16. The charging seat assembly of claim 14, wherein the second charging terminal includes a second cylindrical body mating with a second mating terminal of the charging gun, a second flat end electrically connected to the second connection end portion of the second metal bar, and a second nut riveted into a second riveting hole formed in the second flat end.

17. The charging seat assembly of claim 16, wherein the second nut is threaded to a second connection member to secure the second connection end portion to the second flat end.

18. The charging seat assembly of claim 17, wherein the first flat end and the second flat end are spaced from each other in the thickness direction and parallel to the first connection end portion and the second connection end portion.

19. The charging seat assembly of claim 18, wherein a central axis of the first riveting hole and a second axis of the second riveting hole are parallel to each other and located in a same plane perpendicular to a central axis of the first cylindrical body and a central axis of the second cylindrical body.

20. The charging seat assembly of claim 19, wherein the central axis of the first cylindrical body and the central axis of the second cylindrical body are parallel to each other and located in a same plane perpendicular to the thickness direction of the first flat end and the second flat end.
